(19) United States
(12) Patent Application Publication
(10) Pub. No.: US 2009/0234506 A1
(43) Pub. Date: Sep. 17, 2009

(54) Method for Controlling and/or Regulating Room Temperature in a Building

(76) Inventors: Markus Gwerder, Steinhausen (CH); Jurg Todtli, Zurich (CH)

Correspondence Address: STAAS & HALSEY LLP, SUITE 700, 1201 NEW YORK AVENUE, N.W., WASHINGTON, DC, 20005, US

(21) Appl. No.: 12/083,545

(22) PCT Filed: Sep. 25, 2006
(86) PCT No.: PCT/EP2006/066717

§ 371 Date: Apr. 14, 2008

Related U.S. Application Data
(60) Provisional application No. 60/726,109, filed on Oct. 14, 2005.

(51) Int. Cl. G05B 15/00

(52) U.S. Cl. 700/278

(57) ABSTRACT

A method controls and/or regulates room temperature in a building. The control of the room temperature can be switched between heating, neutral temperature and cooling according to an uncertainty of the internal and external increase of heat, said uncertainty being determined in the construction phase. The uncertainty is determined by a low foreign heating limit and a high foreign heating limit. Said method can be commonly used to control and/or regulate the temperature in rooms or areas, in particular, in buildings, which are cooled and heated by controlling the temperature of the building material, for example, via thermoactive component systems.

### CROSS REFERENCE TO RELATED APPLICATIONS

This application is based on and hereby claims priority to U.S. Application No. 60/726,109, filed on Oct. 14, 2005 and PCT Application No. PCT/EP2006/066717, filed on Sep. 25, 2006, the contents of which are hereby incorporated by reference.

### BACKGROUND

Methods are known for controlling and/or regulating the temperature in rooms or zones in a building. Methods of this type are also advantageously used particularly in buildings that are cooled and heated via the building body, for example via solid concrete elements in floors, ceilings and/or walls. It follows that methods of this type can also be used advantageously for application in a building having thermoactive component systems.

Thermoactive component systems for cooling and heating purposes, so called TABS, come into use in various types of buildings such as, for example, in office buildings, museums, spas, laboratory buildings, training centers, hotels and single-family houses and apartment blocks. With TABS technology, the room temperature is advantageously stabilized by tube batteries installed in floors and ceilings and which are fed with hot water or cooling water, for example. Floors and ceilings made from concrete, for example, are best suited for storing heat or cold. Free cooling with air, for example, is also customary for cooling TABS, the night hours being used in summer for cooling concrete masses via dry or hybrid return coolers, for example. TABS with medium temperatures close to room temperature are basically intended for the use of alternative energies. The TABS technology is also known under the technical terms of component conditioning and concrete core conditioning system.

### SUMMARY

One potential object is to specify a method that can be generally used to control and regulate the temperature in building rooms or room zones and by which it is possible to achieve a desired comfort in conjunction with low energy use.

The inventors propose a method for regulating a room temperature in a building, that switches over between heating, neutral behavior and cooling as a function of an uncertainty, determined in a construction phase of the building, in a knowledge of internal and external heat gains, the uncertainty in the knowledge of the internal and external heat gains being determined by a lower extraneous heat limit and an upper extraneous heat limit

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a diagram relating to the control and/or regulation strategy for low uncertainty in the knowledge of the internal and external heat gains,

FIG. 2 shows a diagram relating to the control and/or regulation strategy for medium uncertainty in the knowledge of the internal and external heat gains,

FIG. 3 shows a diagram relating to the control and/or regulation strategy for high uncertainty in the knowledge of the internal and external heat gains, and

FIG. 4 shows a schematic of an arrangement for controlling and/or regulating a room temperature in a building having thermoactive component systems.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

A method proposed here for controlling and/or regulating a room temperature based on a so-called unknown-but-bounded approach with the aid of which uncertainties in the knowledge of internal and external heat gains can be treated. In particular, the temperature profile in a room is influenced by people, equipment, machines, lighting and absorbed solar radiation. The expression heat gain is used here in general and also stands for extraneous heat or heat load.

The method for controlling and/or regulating a room temperature utilizes a determined, and therefore known lower limit \dot{q}_{g,lb} of the internal and external heat gains, and a determined and therefore known upper limit \dot{q}_{g,ub} of the internal and external heat gains. The difference between the upper limit \dot{q}_{g,ub} and the lower limit \dot{q}_{g,lb} is the uncertainty in the knowledge of the heat gains.

The lower limit \dot{q}_{g,lb} of the internal and external heat gains, and the upper limit \dot{q}_{g,ub} of the internal and external heat gains are determined in a construction phase by the planner of a control system. Thus, in said construction phase no average heat gains are assumed, but a lower limit \dot{q}_{g,lb} known in advance and an upper limit \dot{q}_{g,ub} known in advance are assumed for the internal and external heat gains.

With consideration of the uncertainty in the knowledge of the internal and external heat gains, the procedure in the unknown-but-bounded approach is analogous to a procedure that can be applied with conventional heat curves. Heating and cooling curves are used for heating and cooling. A heat loss through the building carcass is compensated by a heating system with an energy supply \dot{q}_{w}>0, for example by supplying water heated up as appropriate. In contrast therewith, overshooting of a maximum permissible room temperature is prevented by dissipating thermal energy \dot{q}_{w}<0, for example by supplying appropriately cooled water.

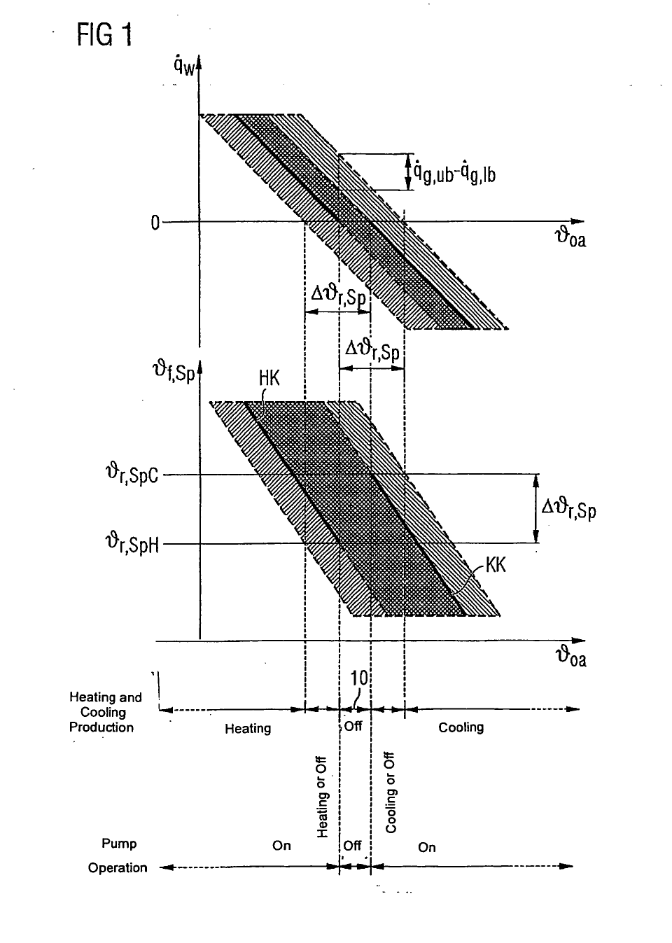

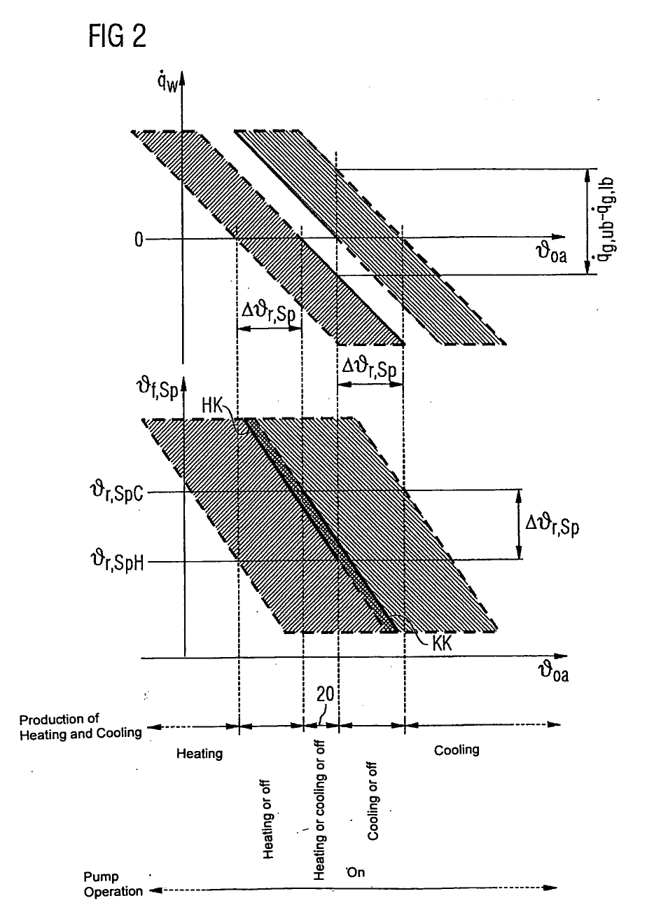

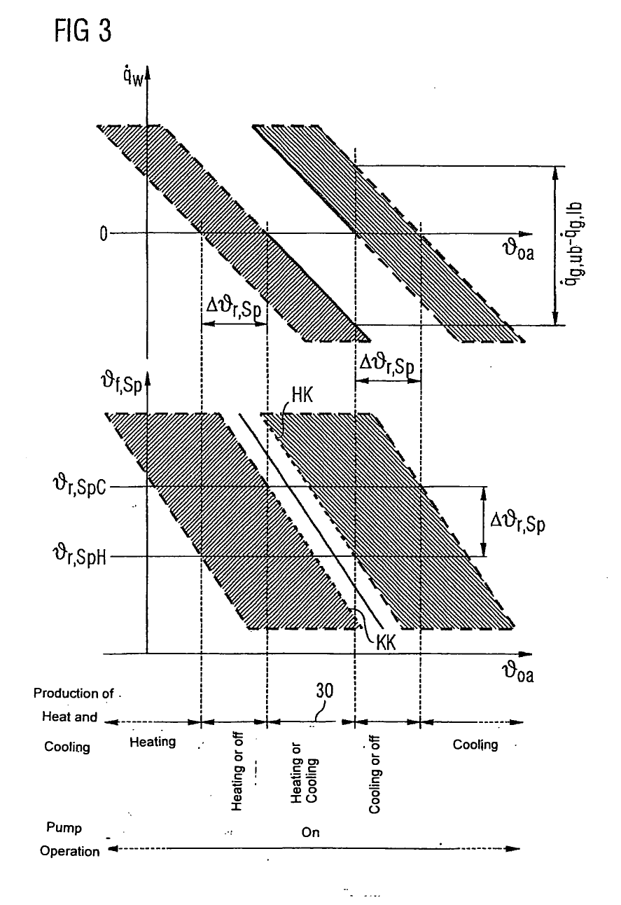

FIG. 1, FIG. 2 and FIG. 3 illustrate the principle of the advantageous method for controlling and/or regulating a room temperature—for example for the purpose of regulating inlet temperature as a function of outside temperature.

Each figure respectively illustrates the desired inlet temperature value θ_{fSp} and the thermal energy \dot{q}_{w} supplied or dissipated by a heating system and cooling system, respectively, as a function of the outside air temperature θₒₐ. Also illustrated are states of a recirculating pump and states of heating or cooling as a function of the outside air temperature θₒₐ.

During regulation of inlet temperature as a function of outside temperature, a desired value θ_{f,Sp} of the inlet temperature is displaced as a function of the outside air temperature θₒₐ in accordance with a heating curve HK or a cooling curve KK. The following three cases are advantageously distinguished depending on the uncertainty in the knowledge of the internal and external heat gains: low uncertainty \dot{q}_{g,ub}−\dot{q}_{g,lb} (FIG. 1), medium uncertainty \dot{q}_{g,ub}−\dot{q}_{g,lb} (FIG. 2), and high uncertainty \dot{q}_{g,ub}−\dot{q}_{g,lb} (FIG. 3).

A determined comfort band Δθ_{r,Sp} is respectively depicted in FIG. 1, FIG. 2 and FIG. 3. The comfort band Δθ_{r,Sp} is defined by a lower desired room temperature value θ_{r,SpH} and an upper desired room temperature value θ_{r,SpC}.

The comfort band Δθ_{r,Sp} is advantageously determined for each room of a building in a fashion depending on desired comfort. The larger the comfort bands, the more energy can be saved with air conditioning the building, and the better TABS is suited for overall coverage of the building. Because of their inertia, TABS are not capable of covering the overall heat load or cooling load of a building in the event of an excessively small comfort band Δθ_{r,Sp.}

When the uncertainty is low, that is to say in the case illustrated in FIG. 1, there is then an area 10 for the outside air temperature θₒₐ in which there is certainly no need either for heating or for cooling. In the event of low uncertainty, thus, no area exists for the outside air temperature θₒₐ in which the heating curve HK and the cooling curve KK overlap.

When a medium uncertainty is present, that is to say in the case illustrated in FIG. 2, there is an area 20 for the outside air temperature θₒₐ in which the heating curve HK and the cooling curve KK overlap, the cooling curve KK running above the heating curve HH. If the outside air temperature θₒₐ lies in the area 20, there is then a need, depending on the actual internal and external heat gain \dot{q}_{g}, either for heating, or for cooling, then for no action at all, that is to say a neutral behavior by switching off heating and cooling.

Given knowledge of the inlet temperature θ_{f} and of a current actuator position, an inlet temperature controller effects the correct action, specifically either heating or cooling, or then switching off heating and cooling. If the inlet temperature θ_{f} lies between the heating curve HK and the cooling curve KK, heating and cooling are then switched off, for example by closing heating and cooling valves. As soon as the inlet temperature θ_{f} overshoots the cooling curve KK, the inlet temperature controller regulates the inlet temperature θ_{f} to the desired inlet temperature value θ_{f,Sp} determined by the cooling curve KK, for example by acting on a cooling valve. As soon as the inlet temperature θ_{f} undershoots the heating curve HK, the inlet temperature controller regulates the inlet temperature θ_{f} to the desired inlet temperature value θ_{f,Sp} determined by the heating curve HK, for example by acting on a heating valve.

When a high uncertainty is present, that is to say in the case illustrated in FIG. 3, there is for the outside air temperature θₒₐ an area 30 in which the heating curve HK and the cooling curve KK overlap, the cooling curve KK lying below the heating curve HK. If the outside air temperature θₒₐ lies in the area 30, there is a need either for heating or for cooling, depending on the actual internal and external heat gain \dot{q}_{g}.

When the uncertainty set by the upper limit \dot{q}_{g,ub} and the lower limit \dot{q}_{g,lb} is high, that is to say in the case illustrated in FIG. 3, it is impossible by regulating the inlet temperature θ_{f} solely as a function of the outside air temperature θₒₐ to keep the room temperature θᵣ for the heat gain \dot{q}_{w} lying in the uncertainty area \dot{q}_{g,ub}−\dot{q}_{g,lb} between the lower desired room temperature value θ_{r,SpH} and the upper desired room temperature value θ_{r,SpC}, that is to say in the targeted comfort band Δθ_{r,Sp.}

In order in the case illustrated in FIG. 3 to keep the room temperature θᵣ in the comfort band Δθ_{r,Sp}, an additional item of information—for example the room temperature θᵣ or the return temperature θᵣₜ or a temperature θ_{c} of the building body, for example the concrete core temperature—is fed back to the inlet temperature controller. An additional system for heating and/or cooling is not required in some circumstances.

The so-called unknown-but-bounded approach can advantageously also be applied correspondingly in order to consider variations in heat gains in building rooms, particularly on the basis of room location, room characteristics and room use, when the room temperature θᵣ of the building rooms cannot be regulated individually, but via a common inlet, for example.

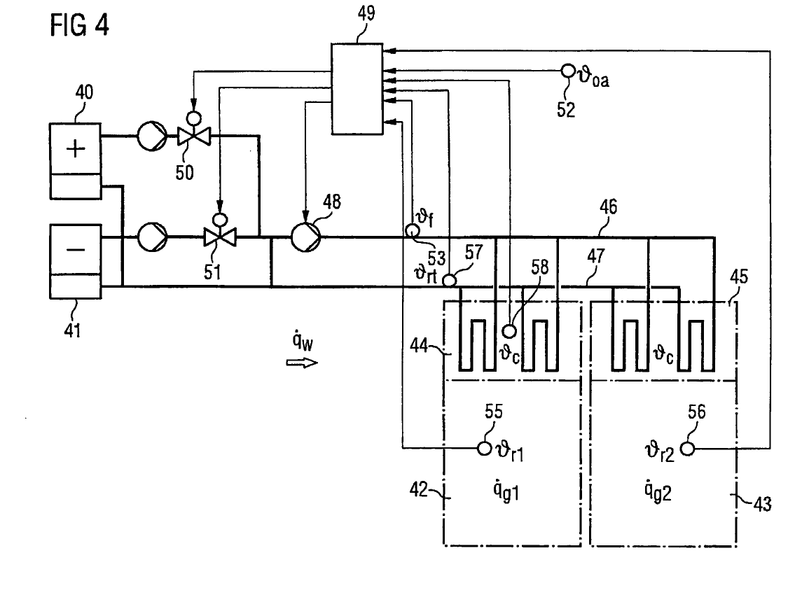

In FIG. 4, 40 signifies a device for heating an energy source, and 41 a device for cooling the energy source. A building having a first room 42 and a second room 43 has a first TABS unit 44 and second TABS unit 45. The two TABS units 44 and 45 can be fed with the aid of the energy source via a common inlet 46 and via a return 47. A recirculating pump 48 that can be controlled by a controller 49 is advantageously arranged in the inlet 46. The inlet 46 is connected to the device 40 for heating the energy source via a heating valve 50 that can be controlled by the controller 49, and is connected to the device 41 for cooling the energy source via a cooling valve 51 that can be controlled by the controller 49.

The energy source is water that can be used, for example, for heating and cooling. Depending on requirement, the device 40 for heating the energy source is, for example, a boiler, a heat pump or another known heat generating apparatus, or a combination of known heat generating apparatuses. The device 41 for cooling is, for example, a cooling tower, a refrigerating machine or another refrigerating apparatus, or a combination of known refrigerating apparatuses.

The outside air temperature θₒₐ can be detected with the aid of a first temperature sensor 52 connected to the controller 49, and the inlet temperature θ_{f} can be detected with the aid of a second temperature sensor 53 connected to the controller 49.

When the uncertainty is low (FIG. 1) and the outside air temperature θₒₐ lies in the area 10, heating and cooling by closing the heating valve 50 and the cooling valve 51 are ruled out, and moreover the recirculating pump 48 is advantageously shut down. Heating is implemented by opening the heating valve 50 with cooling valve 51 closed while, correspondingly, cooling is effected by opening the cooling valve 51 with heating valve 50 closed. The recirculating pump is activated in the event of heating or cooling.

When a medium uncertainty is present (FIG. 2), and the outside air temperature θₒₐ lies in the area 20, there is then a need, depending on the actual internal and external heat gain \dot{q}_{g}, either for heating, for cooling or for no action at all, that is to say a neutral behavior by shutting down heating and cooling.

With knowledge of the inlet temperature θ_{f} and of a current actuator position, the controller 49 effects the correct action, specifically by the heating, or cooling or then shutting down heating and cooling. If the inlet temperature θ_{f} lies between the heating curve HK and the cooling curve KK, the heating valve 50 and the cooling valve 51 are closed. As soon as the inlet temperature θ_{f} overshoots the cooling curve KK, the controller 49 regulates the inlet temperature θ_{f} to the desired inlet temperature θ_{f,Sp}, determined by the cooling curve KK, by acting on the cooling valve 51. As soon as the inlet temperature θ_{f} undershoots the heating curve HK, the controller 49 regulates the inlet temperature θ_{f} to the desired inlet temperature value θ_{f,Sp}, determined by the heating curve HK, by acting on the heating valve 50.

At least one additional item of information is supplied to the controller 49 so that the latter can keep the room temperature θᵣ in the comfort band Δθ_{r,Sp} even given high uncertainty \dot{q}_{g,ub}−\dot{q}_{g,lb} in the knowledge of the internal and external heat gains. The additional information is, for example, the room temperature θᵣ₁, measured by a third temperature sensor 55, of the first room 42, the room temperature θᵣ₂, measured by a fourth temperature sensor 56, of the second room 43, the return temperature θᵣₜ measured by a fifth temperature sensor 57, or the temperature θ_{c} of the building body measured by a sixth temperature sensor 58 in the TABS unit 44.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-19. (canceled)

20. A method for regulating a room temperature in a building, comprising:
switching over between heating, neutral behavior and cooling as a function of an uncertainty, determined in a construction phase of the building, in a knowledge of internal and external heat gains, the uncertainty in the knowledge of the internal and external heat gains being determined by a lower extraneous heat limit and an upper extraneous heat limit.

21. The method as claimed in claim 20, wherein
the uncertainty in the knowledge of the internal and external heat gains is determined based on room location, room characteristics and room use.

22. The method as claimed in claim 20, wherein
the uncertainty in the knowledge of the internal and external heat gains is assigned to one of three different uncertainty levels.

23. The method as claimed in claim 22, wherein switching over between heating, neutral behavior and cooling is a function of:
outside temperature at a first uncertainty level valid for low uncertainty;
the outside temperature and an inlet temperature at a second uncertainty level valid for medium uncertainty;
room temperature or a return temperature or a temperature of a portion of the building at a third uncertainty level valid for high uncertainty.

24. The method as claimed in claim 20, wherein
switching over between heating, neutral behavior and cooling is also a function of variations, determined in a construction phase, in heat gains in building rooms, the variations in the heat gains being determined by the lower extraneous heat limits and the upper extraneous heat limits.

25. The method as claimed in claim 24, wherein
the variations in the heat gains in building rooms are determined based on room location, room characteristics and room use.

26. The method as claimed in claim 24, wherein
the variations in the heat gains are assigned to one of three different levels.

27. The method as claimed in claim 24, wherein
switching over between heating, neutral behavior and cooling is a function of:
outside temperature at a first level valid for a small variation;
outside temperature and an inlet temperature at a second level valid for a medium variation;
e room temperature or a return temperature or a temperature of a portion of the building at a third level valid for a large variation.

28. The method as claimed in claim 20, further comprising calculating at least one manipulated variable of an actuator as a function of the lower extraneous heat limit and the upper extraneous heat limit.

29. The method as claimed in claim 28, wherein
the manipulated variable is calculated also as a function of a comfort band.

30. The method as claimed in claim 28, wherein
the manipulated variable is calculated also as a function of a measured variable and at least one further variable.

31. The method as claimed in claim 30, wherein
the measured variable is an inlet temperature or a return temperature or a component temperature.

32. The method as claimed in claim 30, wherein
the further variable is an outside temperature or a room temperature.

33. The method as claimed in claim 20, wherein
the building has a thermoactive component system TABS.

34. The method as claimed in claim 20, wherein
overshooting of an upper limit value of a comfort band is counteracted by a feedback signal, and undershooting of a lower limit value of the comfort band is counteracted by a feedback signal.

35. The method as claimed in claim 34, wherein
the feedback signal is generated as a function of room temperature detected at an end of an occupancy period.

36. The method as claimed in claim 35, wherein
the feedback signal is generated as a function of a minimum value of room temperature detected in an occupancy period, and of a maximum value of the room temperature detected in the occupancy period.

37. The method as claimed in claim 20, wherein
the upper extraneous heat limit and the lower extraneous heat limit are considered as a function of time.

38. A device for feedback regulation of room temperature using the method in accordance with claim 20.
